(19) United States
(12) Patent Application Publication
(10) Pub. No.: US 2010/0184620 A1
(43) Pub. Date: Jul. 22, 2010

(54) METHOD OF BIOLOGICAL AND MEDICAL DIAGNOSTICS USING IMMUNE PATTERNS OBTAINED WITH ARRAYS OF PEPTIDE PROBES

(76) Inventors: Leszek RYCHLEWSKI, Poznan (PL); Jaroslaw Dastych, Lodz (PL)

Correspondence Address: BLANK ROME LLP, WATERGATE, 600 NEW HAMPSHIRE AVENUE, N.W., WASHINGTON, DC, 20037, US

(21) Appl. No.: 12/691,453

(22) Filed: Jan. 21, 2010

Related U.S. Application Data
(63) Continuation-in-part of application No. 09/791,884, filed on Feb. 26, 2001, now abandoned.
(60) Provisional application No. 60/184,829, filed on Feb. 24, 2000.

(51) Int. Cl. C40B 30/04

(52) U.S. Cl. 506/9

(57) ABSTRACT

Immune-chips, which are arrays of peptides probes are used to obtain a pattern which characterizes the global immune reactivity status of the human or other organism, are described. The peptide probes participate in immune reactions with antibodies and immune receptors of the investigated organisms to generate an immune pattern on the chip, which are detected and stored as patterns in databases. The patterns are then compared with other patterns observed with the same array and obtained under physiological, pathological and experimental conditions from the same or other organisms. The comparison is used to classify the state of the investigated organisms based on similarity to other observed states. The immune chips and the obtained patterns can be used for clinical diagnosis and biological studies, such as the investigation of similarities between physiological, pathological or experimental processes.

### REFERENCE TO RELATED APPLICATIONS

This application is a continuation-in-part of U.S. application Ser. No. 09/791,884, filed Feb. 26, 2001, which in turn claims the benefit of Provisional Application Ser. No. 60/184,829 filed Feb. 24, 2000.

### FIELD OF THE INVENTION

The invention provides a way to characterize the global status of the immune system of the investigated organism by measuring a broad spectrum of immune reactions with a large set of peptide probes used as a sensor (an immune-chip or peptide-chip). The sensor uses technologies from the field of immunology and biotechnology to detect the immune reaction and to generate a pattern (immune pattern). The patterns are stored in databases and annotated with the biological information describing the status of the organism. The database is organized in a way that organisms can be classified according to their state, using common biological and medical knowledge (organisms can be for example classified based on their clinical symptoms or other diagnoses). The patterns are then compared using standard information processing techniques. The patterns can be used for a diagnostic purpose based on the detected similarity with other patterns from organisms with previously known state. Thus the invention provides tools for diagnostics and for the investigation of biological and clinical processes and relates to fields like biology, medicine, information processing (bioinformatics) and others.

### BACKGROUND OF THE INVENTION

The immune system is related to the majority of physiological, pathological or experimental processes underway in many higher organisms or in the human. Pathological changes and the response of the immune system in the organism are currently detected by the presence of particular antibodies such as auto-antibodies, especially anti-nuclear antibodies associated with auto-immune diseases, IgE antibodies directed against allergens associated with allergic diseases and anti-bacterial antibodies associated with infectious diseases. It is known that a significant part of the repertoire of immune reactivities is engaged in immunoregulation and the levels and specificity of different antibodies change with natural physiological process such as aging or pregnancy. Some pathological conditions that usually are not perceived as immunological disorders such as injury also result in long lasting changes in the levels and specificity of circulating antibodies.

Immune activity can be detected directly in vitro by several methods. Typically the immune detection is obtained by visualization of the complex formed by an antibody and an antigen or a hapten. The antigen or the antibody might be noncovalently or covalently linked to the solid support. ELISA is an example of a standard technique of immune detection based on such approach. There are many similar techniques, which are applied to measure the reaction between antibody and a specific antigen.

The state of the art of immune diagnosis is based on two approaches. The determination of the presence of antibodies against a single antigen with methods such as ELISA, RIA or Western blot represents a way to characterize a single activity of the immune system. These tests are generally aimed at the detection of one pathological state of the organism and the antibodies used as markers are selected to be specific to the disease or to the investigated status.

Alternatively the measurement of the total level of a given class of immunoglobulins, i.e. measurement of total IgE or the gamma-globulin fraction in serum with techniques such as ELISA or gel electrophoresis provide non specific characteristics of the production level of the immune system.

Lacroix-Desmazes et al. (Eur. J. Immunal. 1995 (25) pp. 2598-2604) have used a quantitative immunoblotting technique to analyze the repertoires of IgG antibody reactivities of a group of patients with particular immunological diseases.

Jayawickreme et al. (J. Pharmacal. Taxical. 1999 (42) pp. 189-197) have synthesized a bead based peptide library having over 440,000 members. Subsequent to the filing date of provisional application Ser. No. 60/184,829 upon which priority for this application is claimed, Emili et al. published a survey article on large-scale functional analysis using peptide or protein arrays (Nat. Biotechnol. 2000 Apr. 18(4): 393-7).

Heretofore no one has recognized the efficacy and potential of the combination of peptide libraries or arrays as a tool for creating immune patterns.

It would be desirable to be able to create a representation or pattern that characterizes the immune system of an organism.

It would be desirable to create such an immune pattern that was readily converted into an array of data, such as numbers or dots, that could be analyzed and manipulated by automated methods such as optical screening for data input and computer manipulation for purposes of characterizing the data and comparing the data. It would be desirable to form a database with such immune patterns and to use the immune patterns and the database together as a diagnostic tool.

### SUMMARY OF THE INVENTION

The invention provides a representation or pattern that characterizes the immune system of an organism. Furthermore, the invention provides an immune pattern that is easily generated, readily converted into an array of data, such as numbers or dots, that can be analyzed and manipulated by automated methods such as optical screening for data input and computer manipulation for purposes of characterizing the data and comparing the data.

The invention also provides a powerful diagnostic tool by the formation of a database comprising the immune patterns.

In the invention, arrays of peptides (called immune-chips or peptide-chips) are used to obtain a pattern (array of numerical values), which characterizes the global immune reactivity status of the human or other organism. The immune chip comprises a set of peptide probes, which participates in immune reactions with antibodies and immune receptors of the investigated organisms. The immune reaction with all probes on the chip generates the patterns, which are detected and stored as patterns in a database or databases. The patterns are then compared with other patterns observed with the same array and obtained under physiological, pathological and experimental conditions from the same or other organisms. The comparison is used to classify the state of the investigated organisms based on similarity to other observed states. The immune chips and the obtained patterns can be used for clinical diagnosis and biological studies, such as the investigation of similarities between physiological, pathological or experimental processes.

The invention provides a method of generating an immune pattern corresponding to an organism. The method comprises selecting an immune chip containing a reproducible peptide library, and contacting said immune chip with material from an organism, said material containing immune molecules selected from antibodies, T-cell receptors and combinations thereof, wherein a pattern if formed on said chip by an immune reaction of said immune molecules with said reproducible peptide library.

In embodiments of the invention, the method further comprises the step of developing the pattern into a machine-readable 2-dimensional array of regions having a first dimension of n regions and a second dimension of m regions, wherein at least one of the m*n (m times n) regions represents a peptide having a specifically defined sequence.

The invention also provides a method of generating a database of immune patterns corresponding to a group of a least two organisms, the method comprising selecting a first immune chip containing a first reproducible peptide library, and contacting the first immune chip with material extracted from a first organism, the material containing immune molecules selected from antibodies, T-cell receptors and combinations thereof, wherein a first immune pattern is formed on the first chip by an immune reaction of the immune molecules with the first reproducible peptide library, and selecting a second immune chip containing a second reproducible peptide library, the first reproducible peptide library and the second reproducible peptide library being identical or substantially identical, and contacting the second immune chip with material extracted from a second organism, the material containing immune molecules selected from antibodies, T-cell receptors and combinations thereof, wherein a second immune pattern is formed on the second chip by an immune reaction of the immune molecules with the second reproducible peptide library, and forming a database with the first and second immune patterns.

The invention also provides a method of diagnosis using an immune chip comprising generating a database of immune patterns corresponding to a group of at least two organisms, the group of at least two organisms having at least one organism known as having a condition and at least one organism known as not having the same condition, generating an immune pattern for a test organism to be diagnosed, the test organism immune pattern being generated under the same conditions as the database immune patterns, and comparing the test organism immune pattern to the database of immune patterns to determine whether the test organism has or does not have the condition.

The invention additionally provides for databases generated using the methods described above.

### DETAILED DESCRIPTION OF THE INVENTION

The invention is based on the parallel detection of a large number of immune reactions with a set of potentially immune reactive molecules measuring a significant fraction of the total immune reactivity. In embodiments of the invention of the fraction of the total immune reactivity measured is at least 5%, preferably at least 25%, and more preferably at least about 50% to 75% or more of the total immune reactivity of the measured organism. Each probe used in the presented immune chip is not designed to target a specific state of the organism or disease, but represents in contrast an unspecific sensor. A large number of probes are used simultaneously. In embodiments of the invention, the large number of probes are used simultaneously is at least about 10,000, preferably at least about 100,000, and more preferably at least about 300,000. Although arrays of peptide probes on the order of 500,000 or more may be used in the invention, the cost of the array and the benefit of the enhancement of the measurement of total immune reactivity must be balanced. This is especially true in the instances of large diagnostic databases. The measurement of the activity of all of the probes generates an image, which is translated into a pattern. In contrast to the conventional diagnostic strategy the number of potentially detected states is not equal to the number of measurements (probes). As an example, 10 conventional immune tests can be used to screen for 10 conventional immune tests can be used to screen for 10 states of the organisms. On the other hand, the immune chip of the invention with ten probes can generate 2¹⁰ distinct patterns, assuming that each probe can only provide a binary response, a “yes” or “no” answer to the investigated immune reactivity. It is however expected that the response of one probe is not binary and that for each probe the intensity of the reaction can be also detected, stored and taken into account during comparison, which dramatically increases the number of possible patterns obtained with an immune chip of 10 probes. For example, in embodiments of the invention there may be a range of intensities that are measurable on the order of from one to three, or preferably from one to five or more. Thus the immune chip can be used to detect a much larger number of states on the immune system.

The pattern is then compared with patterns obtained for other samples. The samples can be classified and clustered based on diverse criteria, typically based on whether or not the subject has a certain health condition. The term condition, as used herein, is meant to be interpreted broadly, and may cover presence or absence of a disease, the presence or absence of an infection, the presence or absence of an immune response, or the presence or absence of another health condition, such as pregnancy, allergies, etc. Conditions include, but are not limited to viral infections, bacterial infections, fungal infections, malignancies, pre-malignancies and auto-immune diseases. In certain embodiments, the present invention may be used to monitor changes that occur in the immune system over time in a single subject, monitoring changes in immune response as the subject ages. The presence or absence of a condition may be referred to as the clinical status of the subject tested.

Overall, any health even that manifests itself or affects the immune system should be detected using the present invention. The subject classifications may be made to create two sets of samples, one with the condition, the other without, with these samples associated with their respective immune patterns.

Many other classifications of samples and patterns are possible. The comparison of the pattern obtained using a sample from the investigated organism (from the patient) enables to detect pathological and physiological processes based on the inference from organisms (individuals) with known biological status. If for example the pattern is more similar to a pattern from the pool known to have the condition, the subject could be diagnosed as having the condition.

The subjects used in forming the set may be diagnosed as having the condition to be studied using methods known in the art for diagnosing that condition. These include standard clinical diagnoses performed by medical professionals and also include diagnoses made through detection of biomarkers and genetic tests.

Although diagnosis and testing of human subjects is preferred, it is also contemplated that the methods of the present invention may also be used in the diagnosis and testing of other organisms, including domestic and commercial animals.

In contrast to the conventional immune diagnostics, the measurements of the present invention do not always have to rely on the detailed knowledge of particular peptide probes involved in the detected immune reactions. Only the similarities between the obtained reactivity patterns may be taken into account.

Thus, the analysis of the immune system in accordance with the invention yields an enormous amount of information about the general status of the whole organism even if the immune system is not designed or aimed to neutralize the primary agent causing the change of the status.

The invention is based on the combination of the immune detection techniques possible from the use of the immune chip of the invention and data processing procedures for the purpose of creating novel diagnostics approaches. The essence of the invention is the application of a large number of peptides, which are used as immune probes to characterize the total immune reactivity of a sample obtained from a subject. The results provide an estimation of the global reactivity of the immune system of the subject, which is used to characterize the status of the subject, i.e. to detect a large number of conditions.

The diagnostic tool comprises peptide probes which are described in more detail below. The probes represent different binding targets for components of the immune system of the subject (for the antibodies or immune receptors such as T-cell receptors). The probes are exposed to a fluid or tissue sample collected from a subject, which contains the components of the immune system. The fluid or tissue may be blood, plasma, serum, lymph, blister fluid, saliva, tissue material, or plasma or serum containing IgG fractions. The reactivities of all probes are measured using standard detection techniques. The detected immune reactions are transformed into an array of numerical values. The array may be read directly in the form of an optical image or transformed into a digital or numeric array to facilitate manipulation by a computer. The array of numerical values (the immune pattern) represents the result of the application of the immune chip and the main data object used later for the classification of the status of the investigated organism.

Before the immune patterns can be used for diagnostic purpose a set of initial data must be collected. For this purpose a large number of immune patterns is stored in a database and annotated using prior information about the biological or clinical status of the subjects (the diagnoses of the subjects). The database is used as a reference for the later diagnosis and classification of the future subjects.

During later diagnostic testing, the patient (the investigated subject) supplies a fluid containing components of the immune system (antibodies or receptors) using the same conditions as were applied for the collection of the reference material (as when collecting the immune patterns, which populate the reference database). The immune chip is than used to create the immune pattern of the investigated subject. The pattern is then compared with patterns in the reference database using standard data processing techniques (i.e. based on the observed correlation between arrays of values or other procedures as described in detail later). As a result a number of most similar patterns can be extracted from the database. The extracted patterns are annotated using prior biological or clinical knowledge (such as diagnoses) about the previous subjects (as was done during the construction of the database). The extracted annotation can be used to infer the presence or absences of a condition for the investigated subject (based on most similar pattern; the “nearest neighbor” approach).

As an alternative procedure the probability of the subject belonging to a class of subjects can be calculated. The reference database of immune patterns can be clustered based on the annotations using any kind of criteria. For example the subjects can be clustered based on their genetic profile and the resulting risk factors and predispositions to specific diseases. The patterns of the subject can than be used to calculate the average similarity to the patterns from each of the clusters. Based on the calculated similarities the probability to belong to any class can be estimated using standard statistical or stochastic methods such as for example neural networks or support vector machines.

The essence of this embodiment of the invention is thus, to use a pattern created by a large number of immune reactions of the subject's immune system with an immune chip to classify the status of the subject. This classification is based on the similarity of the patterns (arrays of values) between the subject and various reference groups, and can be used to detect pathological conditions (diseases). The main difference of the invention compared with standard immune diagnostics procedures is that no knowledge is required about the specific biological meaning of any single detected immune reactivity. Just the fact that all immune chips used for the diagnosis are produced in the same fashion (i.e., they are reproducible) is enough to enable a diagnostic procedure based on inference using a reference database with a priori biologically annotated patterns. The fact that the function or immune reactivity of the peptides or probes need not be known distinguishes the present invention from other known diagnostics, which are typically based on finding a peptide have a known function, and also require further knowledge associating that peptide function or its immune reactivity with the condition to be diagnosed.

The immune system generates specialized proteins like T cell receptors and antibodies capable to recognize and bind with high affinity to other molecules termed antigens. The majority of antigens are proteins. One antibody interacts with a specific small fragment of the antigen called epitope. The same antibody can interact also with a number of other short peptides, which may or may not have the same amino acid sequence as the epitope of the antigen. A peptide can at the same time interact with a number of different antibodies. Thus the relation between the peptides and the antibodies is not a one to one function. The resolution obtained by the immune chip of the invention may be a one to one correspondence of one spot on the array representing one immune system molecule such as an antibody or T-cell receptor. In preferred embodiments of the invention, each spot represents no more than 10 different immune molecules, preferably no more than 5 different immune molecules.

The indication that two antibodies are different can be accomplished by the observation that both interact with different sets of peptides. It is not necessary to know the peptide sequences or to test all possible peptides to realize that the two antibodies are not identical. It is sufficient to find a single difference, a positive reaction to a peptide with one antibody but not with the other antibody to make such conclusion. Similarly two different mixtures of antibodies or T cell clones can be distinguished by finding peptides that are recognized by one mixture but not by the other. To analyze the qualitative difference between a set of antibodies from the serum of one individual and set of antibodies form another one, it is necessary to find peptides that are recognized by one serum and not by the other. Quantitative differences can be obtained by measuring relative amounts of antibodies from both individuals, which recognize given peptide or sets of peptides.

The essence of this embodiment of the invention is the production of immune patterns, arrays of numerical values, which describe the global status of the immune system of the organism under investigation. The analysis of a large number of immune patterns reveals signals related to specific states of the global immune system which can be specific for various biological or clinical states of the organism. For this purpose, immune molecules such as antibodies, their fragments, T-cell clones, T-cell receptors etc. are exposed to peptide arrays and a high number of immune reactions are visualized. The large set of reaction intensities observed with some peptide probes generates a complex pattern, an image of the immune system. This pattern can be understood as a graphical or numerical representation of sets of peptides that were recognized and sets of peptides that were not recognized by the tested reactive mixture.

This present invention does not necessary employ known and particular antigens, epitopes, or mimotopes and the purposes of this method are not the determination of a chemical structure or sequence of the immune reactive peptides. The purpose of this technique is to obtain an immune pattern for a given sample, and to compare it with patterns obtained with previously tested samples.

Peptide Array Used as Sensor of the Total Immune Reactivity

The immune pattern will be generated using an array of peptide probes. The peptide array is a topologically organized and reproducible set of peptides of known or unknown sequences. These peptides are either synthetic or naturally derived, and are immobilized on a surface. To obtain a maximum of information the number of probes must be as high as possible. For every immune reactive antibody or receptor there is set of peptides which would bind to it. These peptides can vary in length and sequence. Peptides with length between 5 amino acids and ca. 20 are considered preferable. The number of possible amino acid sequence for peptides of this type is very high. Thus only a subset of all possible peptides will be used. This subset is generated during various production and selection steps. There are two types of peptide arrays which may be used in the methods of the present invention.

In the first type (Type A) of peptide arrays, the mixture of peptides with different sequences is used in a physiochemical procedure separating different peptides from a mixture to different area of the surface. Using this approach the peptides are organized topologically on the surface in a reproducible fashion. The surface is then directly used as a peptide array in a procedure measuring immune reaction intensities, which are topologically organized accordingly to the topological organization of the peptides. The measurement is translated into numeric values representing reactivities obtained on different parts of the surface to generate an immune pattern.

In the second type (Type B) of peptide arrays, the peptide probes are mechanically placed in different separated spots and immobilized on the surface. Peptides in a peptide probe in a single spot are used for the production of any array are obtained in one of several ways.
1. Peptides are generated in a deterministic fashion. The synthesis of a peptide with precise definition of the sequence produces a highly reproducible probe. Such a probe consists of one or more peptides of specific, a priori known sequences.
2. A mixture of peptides representing stochastically obtained sequences is synthesized using one of the combinatorial peptide synthesis approaches and used in a single probe. Probes contain many different stochastic mixtures.
3. A mixture of peptides with semi-randomly generated sequences is synthesized and used in a single probe. For example a set of all possible penta-peptides containing sequences starting with alanine, can represent a single probe.
4. Fractions of peptides obtained through physico-chemical procedures separating different peptides from a mixture are used in a single peptide probe. Such fractions are obtained either from a mixture of synthetic peptides or from a biological source of peptides, such as an enzymatic digest of proteins or hydrolysate of proteins.

Peptide arrays, such as combinatorial peptide libraries, can be generated according to the procedure Jayawickreme et al (J Pharmacal. Tacical. 1999 (42) pp. 189-197) who have synthesized a bead based peptide library having over 440,000 members. Also, peptide arrays can be obtained from commercial vendors such as Jerni Bio Tools GmbH of Berlin, Germany.

An example of the present invention is shown in the following section for an immune chip having 100 distinct spots (Type B), each containing one type of peptide with a distinct sequence of seven amino acids (a peptide probe of type 1 above). The chip is produced by chemically binding the selected peptides to a solid support such as nitrocellulose, glass, nylon or other inert polymer or similar material in the form of beads of other forms of solid support. Equal amounts of peptides of a given amino acid sequence are immobilized on separate places of the support, creating spots. The support-material with the peptides distributed across the spots represents the chip.

Procedure to Generic Immune Patterns

In this example, the pattern detection procedure using an immune chip with 100 distinct spots with precisely defined peptides in each probe is considered.

TABLE 1
Two examples of patterns obtained with an Immune Chip with 100 spots.

| | | | | | | | | | | | | | | | | | | | |
|---|---|---|---|---|---|---|---|---|---|---|---|---|---|---|---|---|---|---|---|
| 0 | 0 | 0 | 0 | 0 | 0 | 0 | 0 | 0 | 0 | 0 | 0 | 0 | 0 | 0 | 0 | 0 | 0 | 0 | 0 |
| 1 | 0 | 0 | 0 | 0 | 1 | 0 | 0 | 0 | 1 | 1 | 0 | 0 | 0 | 0 | 0 | 0 | 0 | 0 | 1 |
| 1 | 0 | 0 | 0 | 0 | 0 | 0 | 0 | 0 | 0 | 1 | 0 | 0 | 0 | 0 | 0 | 0 | 0 | 0 | 0 |
| 0 | 0 | 0 | 0 | 0 | 1 | 0 | 3 | 0 | 0 | 0 | 0 | 0 | 0 | 0 | 1 | 0 | 1 | 0 | 0 |
| 0 | 0 | 0 | 0 | 0 | 0 | 0 | 0 | 1 | 0 | 0 | 0 | 0 | 0 | 0 | 0 | 0 | 0 | 1 | 0 |
| 0 | 1 | 0 | 0 | 0 | 0 | 0 | 0 | 0 | 0 | 0 | 1 | 0 | 0 | 0 | 0 | 0 | 0 | 0 | 0 |
| 1 | 0 | 0 | 5 | 0 | 0 | 1 | 0 | 0 | 0 | 1 | 0 | 0 | 1 | 0 | 0 | 1 | 0 | 0 | 0 |
| 0 | 0 | 0 | 0 | 0 | 0 | 0 | 0 | 0 | 0 | 0 | 0 | 0 | 0 | 0 | 0 | 0 | 0 | 0 | 0 |
| 0 | 0 | 0 | 0 | 0 | 0 | 0 | 0 | 0 | 0 | 0 | 0 | 0 | 0 | 0 | 1 | 0 | 0 | 0 | 0 |
| 0 | 0 | 0 | 0 | 0 | 0 | 0 | 0 | 0 | 0 | 0 | 0 | 0 | 0 | 0 | 0 | 0 | 0 | 0 | 0 |

| | |
|---|---|
| Pattern A | Pattern B |

Na values indicate the amount of antibodies bound to different spots of the chip.

100 peptide sets (probes) each of them with a different uniform sequence are immobilized on the surface, organized in a 2 dimensional matrix. This two-dimensional matrix of different peptide probes is then exposed to plasma or serum or partially purified plasma or serum. Other sources of material (i.e., sputum) can be used as well. Following a period of incubation ranging from minutes to hours, the fluid is removed and the solid matrix with chemically immobilized peptides probes is washed with buffer containing saline and detergent.

Detection of the Antibodies and the Developing of the Pattern

Following this washing the immune chip is incubated for several minutes or hours with the solution of antibodies conjugated with fluorescent dye and directed against antibodies, which is a standard technique of immune detection. The immune chip is analyzed using a fluoroimager or similar fluorescence reader and the image of the fluorescent dye associated with the peptide chip is processed and stored.

Other methods of detection of antibodies bound to the surface of the immune chip are known. The detection of antibodies might be accomplished with any of the existing visual detection systems used in immunoblotting. These techniques use antibodies directed against immunoglobulins and conjugated with fluorescent dye, enzyme, or other molecules allowing visualization. A specific subset of this technique is based on indirect labeling where antibodies are conjugated with for example biotin, which then allows for the binding of streptavidin conjugated with a fluorescent dye or enzyme. Other existing techniques are presented in a textbook “Current Protocols in Immunology”, edited by John E. Coligan et al. ISBN 0-471-52276-7 (John Wiley & Sons, Inc. 1994). The preferable visual detection systems, in accordance with the present invention, are the use of antibodies conjugated with fluorescent dye. The techniques employed for detection of antibodies interacting with antigens immobilized on the surface are, for example, presented in following papers: Bower S M, Chantler P D; biotech. Histochem. 1991; 1(1):37-43 “The importance of choice of visualization technique in the use of indirect immunodetection methods: specific reference to the detection of light chain movement on a regulatory myosin”; Bieschke J, Giese A, Schulz-Schaeffer W, Zerr I, Poser S, Eigen M, Kretzschmar H; “Ultrasensitive detective of pathological prion protein aggregates by dual-color scanning for intensely fluorescent targets” Proc Natl Acad Sci USA 2000 May 9;97(10):5468-73.

Comparison of Patterns

Table 1 shows an example of a pattern. The lack of staining of the surface is represented by 0 and results from the lack of antibodies recognizing the probe. The positive staining is represented by numbers 1, 2, 3, 4 and 5, which show increasing relative levels of signal due to the increasing amounts of antibodies bound to the given area of an array. Table 1 shows two results (pattern A and B) obtained using serum from different sources (serum A and B).

There are two kinds of differences between these two patterns. First, the peptides located in row 2 column 6 given a positive signal for serum A having an intensity value of 1 and a negative signal (zero) for serum B. Second, the peptides localized in row 4 column 8 give a higher level of signal (more intensive staining as indicated by the numeric value 5) for serum A than B. Of course, in this example, there is no staining in many other corresponding positions.

The example above illustrates the general idea of the methods of the invention. The immune reactions observed on the surface generate an image, which may be translated into an array of values (digitalized). The array of values produces a pattern used later comparison and analysis. Two general characteristics of the collected data must be guaranteed to obtain and use the immune pattern of the immune system for diagnostic purposes:
1. The largest possible fraction of the total activity of the immune system should be captured.
2. The obtained immune pattern should be reproducible under identical conditions.

The immune chips should be optimized to satisfy both criteria as much as possible.

Processing of Immune Patterns and Application for Biological and Clinical Diagnosis

The inferences based the application of images of the immune system for biological and clinical diagnostics requires an extension of knowledge to be acquired first. A large set of immune chip patterns will be collected first and stored in specifically designed reference database of the present invention. The database will include a great deal of additional biological information about the subject who gave the sample and the nature of the sample used to generate the image. The data will be then used to estimate the variability of the immune patterns obtained with each particular type of the immune chip to enable an approximation of the similarities calculated later during the comparison procedure.

The internal variability of the detection process is estimated using identical samples and several immune chips of the dame type. Information about the temporal variability of the immune system will be collected by measuring the response of the immune systems of one individual organism at several points of time (several hours, days, weeks or years apart). Sample from different persons (or organisms) can be used to approximate the differences between the immune system of different individuals. The analysis of variation between different samples and immune chips of the same type will provide basic statistical information for further processing of the patterns.

Datasets created specifically for chosen conditions represent the main features of the protocol used later for diagnostic purposes. The subjects of samples collected during the setup process of the reference database will be clustered based on their clinical or biological status. An example of a very simple classification can be created by dividing the subjects into a group having the condition and a group not having the condition. The test pattern obtained during the diagnosis process (during the application of the immune chip) can than be compared with the “has the condition” and the “does not have the condition” pools to verify which of the two population has the most similar pattern to the one obtained from the subject.

An immune pattern from an individual can be diagnosed at various times to assess for either changes over time that would indicate the presence of a disease or other undesirable condition or a normal aging pattern that would indicate good health.

Statistical Approaches.

Various standard statistical approaches can be applied to analyze the patterns in the database and to provide the processing of the test pattern and to enable diagnostic inferences. A basic comparison of two patterns can be conducted by calculating the correlation between the values in two arrays of numbers (patterns) obtained from two subjects. The correlation would produce numbers between −1 and +1 and denote dissimilarity or similarity, respectively. Any other metric known from mathematics can be used to compare two arrays of numbers, as will be recognized by one of skill in the art.

An application of the selected metric can be provided by combining it with a simple inference procedure based on the “nearest neighbor” approach. This approach can be used to classify the test pattern obtained from the subject. In this procedure the subject belongs to the category (population), where the most similar pattern (pattern with the highest correlation) is found (i.e. the subject has a condition if the most similar pattern was obtained earlier from a subject who had the condition as well).

The number of probes is theoretically only limited by the associated cost and can be several hundred thousand as described above. The number of organisms and/or patterns in the database is theoretically unlimited and can be 500 or 1,000, several hundred thousand, or millions. The capability to handle that amount data is easily managed by available computers. The numbers patterns needed in the database to present a meaningful statistical sample may vary according to the particular probe set used and theoretically only a small difference in one dot or spot could indicate the difference between an organism having a specific condition and an organism not having the condition. As is discussed above, for example, the immune chip of the invention with ten probes can generate 2¹⁰ distinct patterns (1024), assuming that each probe can only provide a binary response, a “yes” or “no” answer to the investigated immune reactivity.

Using the examples of patterns with 100 spots presented above, a simple hypothetical diagnostic procedure could be follows.
1) A large set of patterns (500) is collected from individuals diagnosed with a condition and another set (also 500) from individuals not diagnosed as having the condition. Each pattern is represented as an array of values i[1 . . . 100].
2) The similarity between all patterns is evaluated using a correlation metric. The similarity Sᵢⱼ (correlation=covariance(i,j)/sqrt(variance(i).variance(j))) between pattern i and j is defined as:

Sᵢⱼ=Σₙ(iₙ−<i>)·(jₙ−<j>)]/sqrt{Σ(iₙ−<i>)·(iₙ−<i>)]Σ[(jₙ−<i>)(jn−<j>)]}
where:
sqrt=square root function
iₙ=value for spot n in pattern i
all sums (n) go from 1 to 100 according to the architecture of the chip
The resulting similarity (Sᵢⱼ) can obtain values between +1 (high similarity) and −1 (dissimilar).
3) To estimate the diagnostic value of the procedure, all mutual similarities between patterns in the test set are collected. For each value of the similarity the likelihood that the two patterns are from the same pool is estimated (using general fitting procedures). The result can be, for example, that for two patterns, which have a similarity of 0.9, the likelihood to be from the same set is over 99% (either both having the condition or both not having the condition).
4) Using the analysis performed on the test set the diagnostic procedure can be conducted. The sample is collected from the patient and al similarities between the new pattern and all patterns stored in the database are calculated. One or more patterns with the highest similarity are selected and the probability of the patient to belong to the same group as the subjects of the selected patterns is calculated. If the patient belongs to the group of individuals having a condition with a high enough significance, further clinical diagnostic procedures can be indicated.

Other measures of similarity as well as more elaborate methods to translate the similarity into probabilities can be taken from the large set of statistical methods aimed to deal with series of values.

A more complex inference procedure can be constructed by evaluating the average similarity of the test pattern to a group of reference patterns. In this procedure, reference patterns are grouped according to a prior criteria (usually based on the status of the subject). Using the metric based on correlation as described above, the similarity to a group is defined as the average correlation, which is equal to the sum of correlations to each representative pattern in the group divided by the number of patterns in the group. The average similarity to each group can again obtain values between −1 and +1 in this example indicating dissimilarity and similarity respectively. Any other standard clustering or classification procedures known from statistics or mathematics can be used for this purpose.

The combination of the metric and the inference procedure chosen for the final diagnostic protocol can be selected based on performance tests conducted on the reference database, where the prediction parameters of the patterns can be easily estimated. For this purpose a jack-knife test can be conducted. For each of the evaluated inference procedures each pattern will be removed once from the reference database and the classification procedure will be conducted. The inference procedure, which correctly classifies the highest number of patterns (where the subject of the test patterns and the subjects of the patterns in the selected class share the feature used earlier as criteria for the classification.

In addition to standard statistical approaches, stochastic approaches like neural networks can be used as well for the classification of the patterns and for final diagnostic purpose. Neural networks can be for example employed to create condition specific pattern recognition programs. For each categorized condition (or generally biological status of the subject) a neural network will be training to respond with the output layer in a way that high values of the output neurons correspond to a high likelihood for the test pattern to belong to the disease specific group of patterns. The sensitivity and specificity of diagnosis can be analyzed separately for every investigated condition and every constructed and trained neural network.

The essence of the invention is however not the procedure used for the classification of patterns or the final inference, but the translation of many individual immune reactivities into an image of the global immune reactivity, a pattern representative for the global status of the immune systems and the translation of the image into a numeric array which can be compared with other arrays in the database. The reference arrays in the database lined with specific disorders (or general biological states) will be used for the diagnostic inference of the procedure.

The general idea of the immune chip can be used in other application areas as well. The relationship between the immune system image and normal aspect of the human organism can be also investigated. The collected data presents the unique opportunity to look at pathological processes from the perspective of the immune system. A comparison of biological processes can be conducted the same say as in the cases of comparing subjects, discussed above. The immune chip could answer the questions about which pathological processes behave the same from the perspective of the immune system. This knowledge could provide potential implication for common treatment strategies. The analysis of imagining results will help understand physiological processes (i.e. aging) of an organism or organ as well.

### EXAMPLE

The following example describes a method of diagnosing an individual for the absence or presence of immunity against infection with Plasmodium falciparum (Pf). The method consists of 5 steps:
1. selecting candidates from two groups of human population: (a) individuals not previously exposed to Plasmodium falciparum and (b) individuals immune against infections with Plasmodium falciparum;
2. creating a peptide array for the assessment of global immunity against pathogens;
3. contacting the peptide chip with the serum of the candidates from the two groups and reading the immune profile of each candidate;
4. training a support vector machine with the immune profiles as input and state of the individual (immune or not) as output; and
5. contacting the serum of the diagnosed individual with the peptide chip, feeding the resulting immune profile to the neural network as input and using the output of the neural network as diagnosis.

1. Selecting Candidates

The selection procedure should ensure that the individuals are correctly assigned to two distinct groups. For the group of immune individual 100 Kenyan subjects were selected from a region with very high prevalence of Pf infection (94.4%-97.8%) amongst children. All subjects were at least 18 years old and had reported at least one clinical episode of malaria. All subjects have not left the region for the last 10 years. For the group of not immune individuals 100 Caucasian subjects were selected from regions with no prevalence of Pf infections, at least 18 years old, that have not traveled to Pf infected regions in their life and had no history of a clinical episode of malaria.

2. Creating a Peptide Chip

1 000 000 peptides of length 13 amino acids were generated randomly. The sequences of these peptides were compared with the human proteome. Each peptide obtained a score between 0 and 13 based on the number of identical amino acids found in the most similar 13-residues-long segment of a human protein. 500 000 peptides with the highest score have been removed from the set. This procedure should increase the number of not-human specific peptides in the peptide array. Subsequently the remaining peptide set was subject to the prediction of continuous B-cell epitopes. Any method, for example as used in ABCpred (Saha, S and Raghava G. P. S. (2006) Prediction of Continuous B-cell Epitopes in an Antigen Using Recurrent Neural Network. Proteins, 65(1),40-48) or in Epitopia (Rubinstein N D, Mayrose I, Pupko T. 2009. A machine-learning approach for predicting B-cell epitopes. Mol. Immunol. 46: 840-847), or any combination thereof can be used for this purpose. Peptides were ranked based on the predicted immunogenicity score and 100 000 peptides with the highest score were kept for printing. The reduction of the number of peptides from 1 000 000 to 100 000 is not required for the diagnostic procedure to function properly but reduces the costs of the protocol significantly. Selected 100 000 peptides were synthesized and printed on solid support based on the procedure described previously (Breitling F, Poustka A, Groβ K H, Dübel S, and Saffrich R. Method and devices for applying substances to a support, especially monomers for the combinatorial synthesis of molecule libraries. Patent family: EP1140977B1, US20020006672A1 (1999)).

3. Contacting the Peptide Chip With the Serum

Peptide arrays were incubated in serum for 3 hours, at room temperature. Antibodies where visualized by addition of Cy3-conjugated secondary Antibodies (Jackson ImmunoResearch) and scanned in a ScanArray 4000 laser confocal scanner and quantified with QuantArray (GSI Lumonics, Billerica, Mass.). The resulting immune profiles were stored in a database. Each immune profile was annotated with a label immune or not-immune according to the group membership of the subject.

4. Training a Support Vector Machine (SVM)

A Support Vector Machine (Corinna Cortes and V. Vapnik, “Support-Vector Networks”, Machine Learning, 20, 1995) algorithm, a machine learning method, was used to process the immune profiles for the purpose of constructing a predictive method with diagnostic properties. The algorithm is available from different source, for example from here: http://svmlight.joachims.org/. Classifying data is a common task in machine learning. Given data points, each belonging to one of two classes (positive or negative), the goal is to decide which class a new data point will be in. In the case of support vector machines, a data point is viewed as a p-dimensional vector (a list of p numbers). The method attempts to separate such points with a p-1-dimensional hyperplane. This is called a linear classifier.

The profiles converted into arrays of 100 000 values were used as training sets. The positive set represented immune profiles of candidates immune to Pf and the negative set represented the immune profiles of candidates not immune to Pf. A simple linear kernel was used during the training procedure. The quality of the training procedure was assessed using a leave-one-out (jackknife) test. The training was conducted using all 200 immune profiles but one. The one profile, which was left out, was used for testing. It was supplied to the SVM model and the SVM based prediction was compared with the correct classification of the subject. After selecting all of the 200 profiles as testing profile, the method obtained total precision and recall values of above 97%.

5. Performing Diagnosis for New Individuals

Exactly the same peptide array as created in step 2 and the trained SVM model created in step 4 must be used for classifying the diagnosed individual based on his immune profile into two groups: immune or not-immune. For this purpose the serum of the individual is contacted with the peptide chip described in step 2. The resulting immune reactions and immune profile is read as described in step 3. The immune profile, converted into an array of 100 000 values is used as input vector for the SVM model trained in step 4. The SVM algorithm will classify the immune profile and the individual (the subject of the serum) as immune or not immune and provide a confidence value for the classification.

The foregoing embodiments are intended to illustrate and not limit the invention. It will be apparent that various modifications can be made without departing from the spirit and scope of the invention as defined by the appended claims.

What is claimed is:

1. A method for diagnosing the clinical status of a subject organism, comprising:
selecting a group of organisms with known clinical status;
providing an immune chip for each of the subjects in the group, the immune chip having a reproducible peptide library with at least ten probes, wherein one or more of the probes is not an epitope or mimotope known to be indicative for a disease or clinical status at the time that the method is performed; and wherein the immune chips are made using the same peptide library;
contacting each immune chip with material from each of the subject organisms in the group individually; wherein said material contains immune molecules selected from antibodies, T-cell receptors and combinations thereof; wherein a pattern is formed on said immune chip by immune reactions of said immune molecules with said reproducible peptide library;
storing the formed patterns for each subject organism in the group in a database together with the clinical status for each subject organism;
selecting a subject clinical status to be investigated for the subject organism;
dividing the database into two sets: a first set of patterns belonging to subject organisms with the tested clinical status and a second set of patterns belonging to subject organisms without the tested clinical status;
determining the highest observed similarity between a pattern in the first set with a pattern in the second set; wherein the highest observed similarity between the patterns is the threshold similarity for the subject clinical status;
providing a subject immune chip made from the same peptide library as the immune chips used in forming the patterns in the database;
contacting the subject immune chip with material from the subject organism; wherein said material contains immune molecules selected from antibodies, T-cell receptors and combinations thereof; wherein a pattern is formed on said immune chip by immune reactions of said immune molecules with said reproducible peptide library; and
comparing the pattern formed by the subject immune chip with the patterns in the database, wherein the subject organism is diagnosed as having the same clinical status as the clinical status of the organisms whose patterns are part of the first set if the most similar pattern belongs to the first set and if the subject similarity is above the threshold for the subject clinical status.

2. The method according to claim 1, wherein said pattern is machine readable.

3. The method according to claim 1, wherein said reproducible peptide library is synthetic and has peptides of from 3 amino acids units to about 20 amino acid units.

4. The method according to claim 1, wherein the subject immune chip pattern is a 2-dimensional representation of the global immune system fraction of the subject organism.

5. The method according to claim 1 wherein said reproducible peptide library contains epitopes and mimotopes.

6. The method according to claim 1 wherein at least about 1000 immune patterns are formed, each from an additional organism to create a database from said at least about 1000 immune patterns.

7. The method according to claim 1, wherein each pattern may have one of at least three values representing the magnitude of the immune reaction.

8. The method according to claim 1 wherein said database is stored in a computer.

9. The method according to claim 1, wherein said reproducible peptide library is a combinatorial library with at least 10,000 different sequences.

10. The method according to claim 1, wherein said reproducible peptide library is a combinatorial library with at least 300,000 different sequences.

11. The method according to claim 1, wherein the reproducible peptide library comprises one or more probes for which the amino acid sequence of the probe has not been determined.

12. The method according to claim 1, wherein the reproducible peptide library consists of probes for which the amino acid sequence of the probe has not been determined.

13. The method of claim 1, wherein the immune chips are generated by physicochemical separation of the peptide library before application to the immune chip.

14. A method for diagnosing the clinical status of a subject organism, comprising:
selecting a group of organisms with known clinical status,
providing an immune chip for each of the organisms in the group, the immune chip having a reproducible peptide library with at least ten probes, wherein one or more of the probes is not an epitope or mimotope known to be indicative for a disease or clinical status at the time that the method is performed; and wherein the immune chips are made using the same peptide library;
contacting each immune chip with material from each of the organisms in the group individually; wherein said material contains immune molecules selected from antibodies, T-cell receptors and combinations thereof; wherein a pattern is formed on said immune chip by immune reactions of said immune molecules with said reproducible peptide library;
using the formed patterns in association with their known clinical statuses as training groups for a statistical or stochastic classification method;
providing a subject immune chip made from the same peptide library as the immune chips used in forming the patterns in the database;
contacting the subject immune chip with material from the subject organism; wherein said material contains immune molecules selected from antibodies, T-cell receptors and combinations thereof; wherein a pattern is formed on said immune chip by immune reactions of said immune molecules with said reproducible peptide library; and
comparing the pattern formed by the subject immune chip with the trained statistical or stochastic classification method; wherein the subject organism is diagnosed as having the same clinical status as organisms in the classification method with similar patterns if the confidence value is greater than about 90%.

15. The method according to claim 14, wherein said pattern is machine readable.

16. The method according to claim 14, wherein said reproducible peptide library is synthetic and has peptides of from 3 amino acids units to about 20 amino acid units.

17. The method according to claim 14, wherein the subject immune chip pattern is a 2-dimensional representation of the global immune system fraction of the subject organism.

18. The method according to claim 14, wherein said reproducible peptide library contains epitopes and mimotopes.

19. The method according to claim 14, wherein at least about 1000 immune patterns are formed, each from an additional subject organism to create a database from said at least about 1000 immune patterns.

20. The method according to claim 14, wherein each pattern may have one of at least three values representing the magnitude of the immune reaction.

21. The method according to claim 14, wherein said database is stored in a computer.

22. The method according to claim 14, wherein said reproducible peptide library is a combinatorial library with at least 10,000 different sequences.

23. The method according to claim 14, wherein said reproducible peptide library is a combinatorial library with at least 300,000 different sequences.

24. The method according to claim 14, wherein the reproducible peptide library comprises one or more probes for which the amino acid sequence of the probe has not been determined.

25. The method according to claim 14, wherein the reproducible peptide library consists of probes for which the amino acid sequence of the probe has not been determined.

26. The method of claim 14, wherein the immune chips are generated by physicochemical separation of the peptide library before application to the immune chip.

27. The method of claim 14, wherein the confidence value is greater than about 97%.
